(19) United States
(12) Patent Application Publication
(10) Pub. No.: US 2026/0365074 A1
(43) Pub. Date: Nov. 19, 2026

(54) APPARATUS AND METHOD FOR MANAGING A BATTERY IN ELECTRIFIED VEHICLES

(71) Applicants: HYUNDAI MOTOR COMPANY, Seoul (KR); KIA CORPORATION, Seoul (KR)

(72) Inventors: Ki Young Lee, Hwaseong-si (KR); Yoon Sung Choi, Hwaseong-si (KR); Jae Won Kim, Hwaseong-si (KR)

(73) Assignees: HYUNDAI MOTOR COMPANY, Seoul (KR); KIA CORPORATION, Seoul (KR)

(21) Appl. No.: 19/388,603

(22) Filed: Nov. 13, 2025

(30) Foreign Application Priority Data
May 19, 2025 (KR) 10-2025-0064796

(51) Int. Cl. B60L 58/16; B60L 58/26; H01M 10/42

(52) U.S. Cl. CPC B60L 58/16; B60L 58/26; H01M 10/425; B60L 2240/545; B60L 2240/547; H01M 2010/4271

(57) ABSTRACT

An apparatus for managing a battery in an electrified vehicle includes a memory configured to store state information values including temperature, voltage, and resistance of the battery of the electrified vehicle over time. The apparatus also includes a processor configured to determine whether the battery is abnormal based on a number of times and a duration that the state information values of the battery are included in a preset abnormality interval. The apparatus further includes a communication device configured to transmit an indication of an abnormal status of the battery.

### CROSS REFERENCE TO RELATED APPLICATION

The present application claims the benefit of and priority to Korean Patent Applications No. 10-2025-0064796, filed on May 19, 2025, the entire contents of which are hereby incorporated herein by reference.

### TECHNICAL FIELD

The present disclosure relates to an apparatus and method for managing a battery, the apparatus and method diagnosing whether a battery of an electrified vehicle has an abnormality and transmitting a notification of the abnormality diagnosis.

### BACKGROUND

Recently, eco-friendly vehicles equipped with an electric motor as a power source have been increasing in popularity due to an increase of interest in the environment. An eco-friendly vehicle is also referred to as an electrified vehicle. A Hybrid Electric Vehicle (HEV) or an Electric Vehicle (EV) is representative example of eco-friendly vehicles.

The battery applied to electrified vehicles may be a secondary battery capable of repeated charging and discharging. The secondary battery used in electrified vehicles may be various types of batteries, such as a lithium-ion polymer battery (LIB), a lithium iron phosphate battery (LFPB), and an all-solid-state battery (ASSB).

Such batteries may have a temperature range and a voltage range required for stable operation due to their chemical characteristics. Accordingly, a battery controller, such as a Battery Management System (BMS), may monitor state information such as voltage and temperature of the battery. Further, when the state information value of a battery deviates from the range required for stable operation and reaches a preset reference value, a battery management system may diagnose the battery as abnormal and may generate a Diagnostic Trouble Code (DTC) corresponding to the type of the abnormality.

When an abnormality is uniformly diagnosed based on whether the state information value of a battery has reached a reference value, as described above, unnecessary costs may occur due to a false positive diagnosis in which the battery is diagnosed as abnormal despite having no actual abnormality.

The description provided in this Background section as a related art of the present disclosure is merely for enhancing understanding of the background of the present disclosure and should not be construed as being included in the related art already known to those having ordinary skill in the art.

### SUMMARY

Accordingly, an objective of the present disclosure is to provide an apparatus and method for managing a battery in an electrified vehicle, that can reliably diagnose whether the battery has an abnormality.

The technical subjects of the present disclosure are not limited to the technical subjects described above. Other technical subjects that are not stated herein should be more clearly understood by those having ordinary skill in the art from the following description.

According to an embodiment, an apparatus for managing a battery in an electrified vehicle is provided. The apparatus includes a memory configured to store state information values including temperature, voltage, and resistance of the battery of the electrified vehicle over time. The apparatus also includes a processor configured to determine whether the battery has an abnormality based on a number of times and a duration that the state information values of the battery are included in a preset abnormality interval. The apparatus additionally includes a communication device configured to transmit an indication of an abnormal status of the battery to an external device.

In an embodiment, the preset abnormality interval may be set between a preset normal operation limit value of the battery and a diagnostic trouble code (DTC) trigger threshold.

In an embodiment, the DTC trigger threshold may be received from a server.

In an embodiment, the DTC trigger threshold received from the server may be determined based on a distribution of a plurality of state information values and a frequency of abnormality occurrences. The distribution and the frequency may be derived from batteries of a plurality of electrified vehicles.

In an embodiment, the DTC trigger threshold may be determined based on the type, mileage, and age of the electrified vehicle.

In an embodiment, the processor may be configured to determine an over-temperature abnormality interval based on a maximum operating temperature and a preset upper limit temperature of the battery, and determine whether the battery has an over-temperature abnormality based on a number of times and a duration that the temperature of the battery is within the over-temperature abnormality interval.

In an embodiment, the processor may be configured to determine an over-voltage abnormality interval based on a maximum operating voltage and a preset upper limit voltage of the battery, and determine whether the battery has an over-voltage abnormality based on a number of times and a duration that the voltage of the battery is within the over-voltage abnormality interval.

In an embodiment, the processor may be configured to determine a lower-voltage abnormality interval based on a minimum operating voltage and a preset lower limit voltage of the battery, and determine whether the battery has a lower-voltage abnormality based on a number of times and a duration that the voltage of the battery is within the lower-voltage abnormality interval.

In an embodiment, the processor may be configured to determine a resistance abnormality interval based on minimum operating resistance and preset lower limit resistance of the battery, and determine whether the battery has a resistance abnormality based on a number of times and a duration that the resistance of the battery is within the resistance abnormality interval.

In an embodiment, the processor may be configured to selectively store, in the memory, at least some state information based on variability of state information values over time.

In an embodiment, the processor may be configured to store, in the memory, state information values, excluding a state information value measured at a specific time when a difference between the state information value measured at the specific time and a state information value measured immediately before the specific time is greater than a predetermined reference value, or when a difference between the state information value measured at the specific time and a state information value measured immediately after the specific time is greater than the predetermined reference value.

In an, the processor may be configured to determine that the battery is in an abnormal state when the number of times a state information value of the battery is within the preset abnormality interval exceeds a predetermined reference number of times, or when duration for which a state information value of the battery is within the preset abnormality interval exceeds a predetermined reference time.

According to another embodiment, a method of managing a battery in an electrified vehicle is provided. The method includes storing state information values including temperature, voltage, and resistance of a battery of an electrified vehicle over time. The method also includes determining whether the battery has an abnormality based on a number of times and a duration that the state information values of the battery are included in a preset abnormality interval set between a preset normal operating limit value of the battery and a diagnostic trouble code (DTC) trigger threshold. The method additionally includes transmitting an indication of an abnormal status of the battery.

In an embodiment, the method may include receiving the DTC trigger threshold from a server.

In an embodiment, the DTC trigger threshold received from the server may be determined in consideration of a distribution of a plurality of state information values and a frequency of abnormality occurrences of batteries of a plurality of electrified vehicles.

In an embodiment, the DTC trigger threshold may be determined based on a type, mileage, and age of the electrified vehicle.

In an embodiment, the normal operation limit value may further include a maximum operating temperature, a maximum operating voltage, a minimum operating voltage, and minimum operating resistance of the battery.

In an embodiment, storing the state information values may include selectively storing at least some state information in consideration of variability of state information values over time.

In an embodiment, storing the state information values may include storing state information values, excluding a state information value measured at a specific time when a difference between the state information value measured at the specific time and a state information value measured immediately before the specific time is greater than a predetermined exclusion reference value, or when a difference between the state information value measured at the specific time and a state information value measured immediately after the specific time is greater than the predetermined exclusion reference value.

In an embodiment, determining whether the battery has an abnormality may further include determining that the battery is in an abnormal state when a number of times a state information value of the battery is within the preset abnormality interval exceeds a predetermined reference number of times, or when a duration for which a state information value of the battery is within the preset abnormality interval exceeds a predetermined reference time.

According to embodiments of the present disclosure, state information including the temperature, voltage, and resistance of a battery is monitored, and an abnormality of the battery is diagnosed based on a number of times and a duration that each state information is within a predetermined abnormality interval, whereby it is possible to prevent over-diagnosis and ensure the reliability of the diagnosis result.

Further, it is possible to optimize diagnostic criteria by receiving, from a server, a DTC threshold adjusted based on state information and abnormality diagnosis history collected from a plurality of EVs.

The effects of the present disclosure are not limited to the effects described above. Other effects not mentioned herein should be more clearly understood by those having ordinary skill in the art from the following description.

### BRIEF DESCRIPTION OF THE DRAWINGS

FIG. 1 is a block diagram illustrating the configuration of an apparatus for managing a battery in an electrified vehicle, a battery, and a server, according to an embodiment;

FIG. 2 is a graph illustrating an example of a battery temperature value stored in a memory over time, according to an embodiment;

FIG. 3 is a graph illustrating an example of state information received by a processor over time, according to an embodiment;

FIG. 4 is a flowchart illustrating an example of a process in which a processor stores received state information, excluding a portion of the state information, in the memory, according to an embodiment; and

FIG. 5 is a flowchart illustrating an example of a process in which a sets an abnormality interval and determines whether the battery has an abnormality based on the abnormality interval, according to an embodiment.

### DETAILED DESCRIPTION

Hereafter, embodiments of the present disclosure are described in detail with reference to the accompanying drawings. In the accompanying drawings, the same or similar components are designated by the same reference numerals regardless of the numbers of figures, and are not repeatedly described. Terms “module” and “unit” that are used for components in the following description are used merely for the convenience of description without having discriminate meanings or functions. In the following description, where it was decided that a detailed description of known technologies related to the present disclosure would make the subject matter of the embodiments described herein unclear, the detailed description thereof has been omitted. Further, the accompanying drawings are provided merely to enhance understanding of embodiments disclosed in the specification. The technical spirit of the present disclosure is not limited by the accompanying drawings, and various changes, equivalents, and replacements should be understood as being included in the spirit and scope of the present disclosure.

Terms including ordinal numbers such as “first” and “second” may be used to describe various components, but the components should not be construed as being limited to the terms. The terms are used only to distinguish one component from another component.

It should be understood that when an element is referred to as being “connected to” or “coupled to” another element, the element may be connected directly to or coupled directly to the other element or may be connected to or coupled to the other element with the one or more further elements therebetween. On the other hand, it should be understood that when an element is referred to as being “connected directly to” or “coupled directly to” another element, the element is connected to or coupled to the other element without any further elements therebetween.

Singular forms are intended to include plural forms unless the context clearly indicates otherwise.

It should be further understood that the terms such as “include”, “including”, “comprise”, “comprising”, “have”, “having”, or the like, used in this specification specify the presence of stated features, steps, operations, components, parts, or a combination thereof, but do not preclude the presence or addition of one or more other features, numerals, steps, operations, components, parts, or a combination thereof.

A unit or a control unit that is included in names such as a motor control unit (MCU) is only a term that is generally used to name a controller that controls specific functions of a vehicle, rather than mean a generic function unit. For example, each control unit may include a communication device that communicates with another control unit or a sensor to control corresponding functions, a memory that stores an operating system or logic commands and input/output information, and one or more processors that perform determination, calculation, decision, etc. for controlling the corresponding functions.

When a component, controller, device, element, apparatus, unit or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, or the like may separately embody or be included with one or more processors and a memory, such as a non-transitory computer-readable media, as part of the apparatus. The one or more processors may be configured to implement computer-readable instructions stored in the memory to perform the described operations.

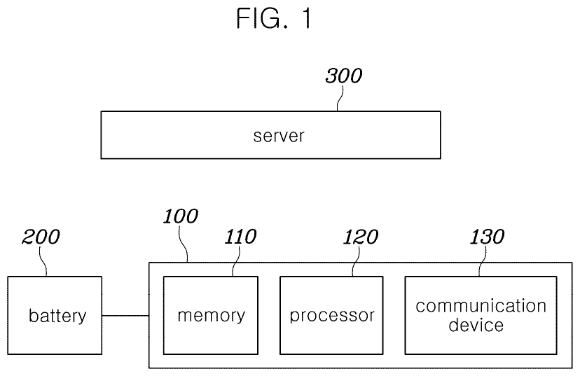

FIG. 1 is a block diagram illustrating the configuration of an apparatus for managing a battery in an electrified vehicle, a battery, and a server, according to an embodiment.

Referring to FIG. 1, an apparatus 100 for managing a battery in an electrified vehicle according to an embodiment may include a memory 110, a processor 120, and a communication device 130.

The memory 110 may store state information such as voltage, current, resistance, and temperature of a battery 200 acquired from sensors (not shown) and other controllers. Further, the memory 110 may receive and store abnormal diagnosis history of the battery 200 from the processor 120.

The processor 120 may determine whether the battery 200 has an abnormality based on state information such as voltage, current, and temperature of the battery 200 from the memory 110 in accordance with a preset diagnostic criterion. Further, the processor 120 may generate various control signals for stable operation of the battery 200.

The communication device 130 may perform information transmission and reception between the apparatus 100 for managing a battery and other controllers.

For example, the communication device 130 may transmit the diagnostic history of abnormalities of the battery 200 to other controllers via Controller Area Network (CAN) communication and/or may receive control commands from other controllers and transmit the control commands to the processor 120.

The server 300 may receive state information and diagnostic history of abnormalities for a plurality of batteries from a plurality of apparatuses for managing a battery. Based on the received state information diagnostic history of abnormalities, the server 300 may provide information to the apparatus 100 for managing a battery to newly determine diagnostic criteria for effectively diagnosing abnormalities of the battery 200.

In another example, the server 300 may diagnose abnormalities of the battery 200 independently from the apparatus 100 for managing a battery based on state information of the battery 200 and may transmit the diagnostic history to the apparatus 100 for managing a battery.

In the following description, for convenience, it is assumed that the apparatus 100 determines whether the battery 200 has an abnormality and the server 300 transmits only information for newly determining diagnostic criteria to the apparatus 100.

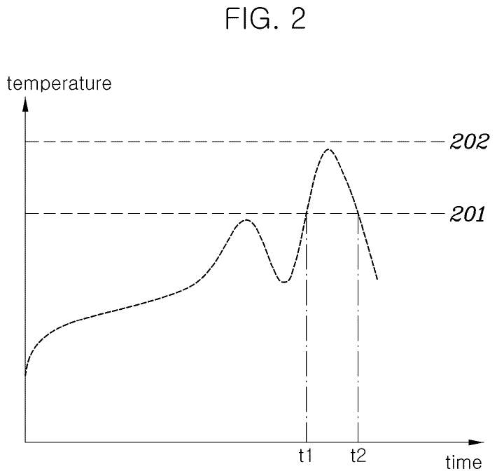

FIG. 2 is a graph illustrating an example of a battery temperature value stored in a memory over time, according to an embodiment.

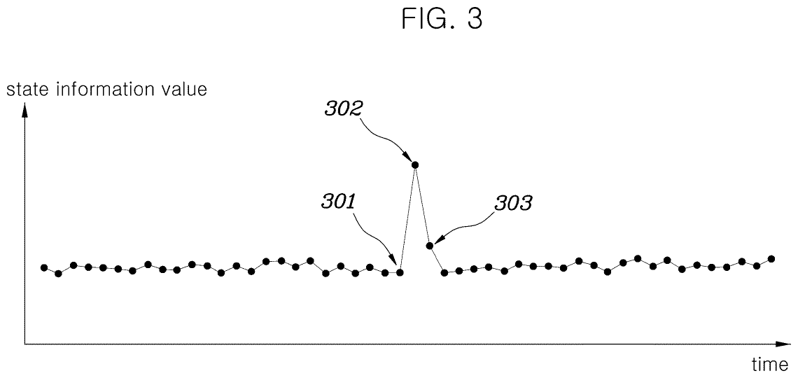

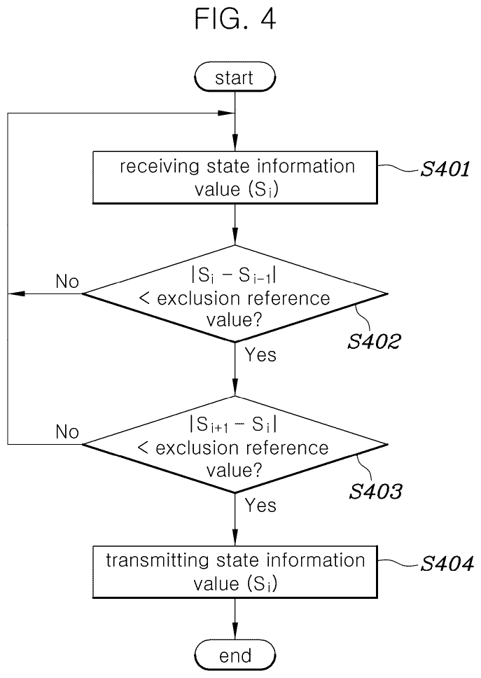

Referring to FIG. 2, the memory 110 may receive and store state information data such as temperature, voltage, and resistance values of the battery 200 from sensors (not shown) and the processor 120. In an embodiment, the memory 110 may store the received state information data, excluding a portion thereof, to ensure the reliability of the data. An example in which received state information data is stored excluding a portion thereof, according to an embodiment, is described in more detail below with reference to FIGS. 3-4.

The processor 120 may determine whether the battery 200 has an abnormality based on whether the state information values stored in the memory 110 are included in a preset abnormality interval.

As an example of a method of setting an abnormality interval, the processor 120 may set an abnormality interval between a preset normal operation limit value of the battery 200 and a DTC trigger threshold (or DTC threshold).

For example, the processor 120 may determine an over-temperature abnormality interval corresponding to the temperature of the battery 200 based on an upper temperature limit 201 for normal operation of the battery 200 and a DTC threshold 202 corresponding to a DTC caused by an over-temperature abnormality. The processor 120 may determine whether the battery 200 has an over-temperature abnormality based on the number of times and duration that the temperature of the battery is within the over-temperature abnormality interval.

As another example, the processor 120 may determine an over-voltage abnormality interval based on an upper voltage limit for normal operation of the battery 200 and a DTC threshold for over-voltage abnormality. The processor 120 may determine an under-voltage abnormality interval based on a lower voltage limit and a DTC threshold for under-voltage abnormality.

As yet another example, the processor 120 may determine whether there is a resistance abnormality based on a resistance abnormality interval corresponding to the resistance of the battery 200. The battery 200 must be insulated from the surroundings when a main relay is open, but when the insulation resistance of the main relay decreases, leakage current may occur. Therefore, the processor 120 may determine a resistance abnormality interval of the main relay based on minimum resistance of the main relay for satisfying insulation conditions of the battery 200 and a DTC threshold for abnormal resistance of the main relay.

As an example of a method by which the processor 120 determines whether the battery 200 has an abnormality, the processor 120 may determine that the battery 200 has an abnormality when the number of times the state information values stored in the memory 110 are included in the abnormality interval satisfies a reference number criterion (e.g., exceeds a reference number of times) and/or when the accumulated time (t2−t1) included in the abnormality interval satisfies a reference time criterion (e.g., exceeds a reference time). The reference number of times and the reference time may follow preset values or may be received from the server 300, for example.

FIG. 3 is a graph illustrating an example of state information values received by a processor over time, according to an embodiment. FIG. 4 is a flow chart illustrating an example of a process in which the processor transmits the received state information to the memory, excluding a portion of the received state information values, according to an embodiment.

Referring to FIG. 3, a graph representing a type of state information received by the processor from sensors over time is illustrated, according to an embodiment.

The processor 120 may transmit to the memory 110 the received state information excluding a piece (e.g., a portion) of state information 302 having a large difference from adjacent pieces (e.g., portions) of state information 301 and 303, in consideration of the variability of the received state information.

Referring to FIG. 4, in an operation S401, the processor 120 may receive state information such as voltage and temperature of the battery 200 from sensors.

In an operation S404, the processor 120 may transmit to the memory 110 the state information excluding a case in which the difference between a state information value Sᵢ at a specific point in time and a state information value Sᵢ₋₁ at a previous point in time satisfies an exclusion criterion, e.g., is greater than a preset exclusion reference value (No in an operation S402), or the difference between the state information value Sᵢ at a specific point in time and a state information value Sᵢ₊₁ at a subsequent point in time satisfies an exclusion criterion, e.g., is greater than the preset exclusion reference value (No in an operation S403).

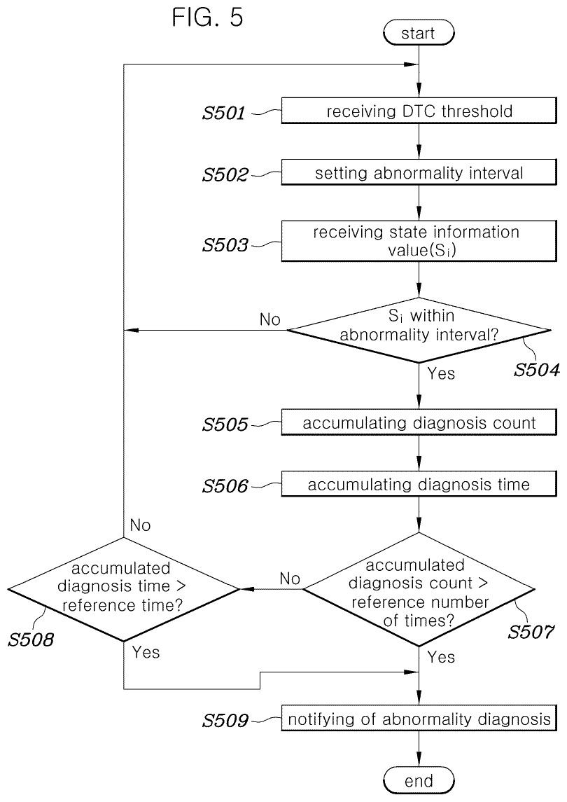

FIG. 5 is a flowchart illustrating an example of a process in which a processor embodiment sets an abnormal interval and determines whether the battery has an abnormality based on the abnormality interval, according to an embodiment.

Referring to FIG. 5, in an operation S501, the processor 120 may receive a DTC threshold from the server 300.

For example, the server 300 may receive the temperature of each battery and a notification of over-temperature abnormality diagnosis from a plurality apparatuses for managing a battery, and may adjust the DTC threshold downward when the proportion of batteries diagnosed with an over-temperature abnormality is too small (e.g., is less than a preset threshold proportion).

As another example, the server 300 may adjust the DTC threshold based on information such as the distribution of state information including the maximum value and the minimum value of the state information, and the type, mileage, and age of the electrified vehicle equipped with the battery 200. When the mileage of the vehicle is long or the vehicle is aged, the probability of an abnormality occurring in the battery 200 increases. Accordingly, the server 300 may narrow the width of the abnormality interval by adjusting the DTC threshold. On the other hand, even if the mileage of the vehicle is below a predetermined distance, the server 300 may narrow the width of the abnormality interval by adjusting the DTC threshold in order to screen for initial defects in the battery 200.

The processor 120 may receive the adjusted DTC threshold from the server 300 and adjust the existing DTC threshold accordingly. However, even when the processor 120 does not receive the DTC threshold from the server 300, the processor 120 may diagnose an abnormality of the battery 200 based on a preset DTC threshold.

In an operation S502, the processor 120 may newly set the abnormality interval based on the adjusted DTC threshold.

For example, the processor 120 may set, as an abnormality interval, an interval between an upper limit temperature required for normal operation of the battery 200 and the DTC threshold corresponding to an over-temperature abnormality. If the adjusted DTC threshold is smaller than the existing DTC threshold corresponding to an over-temperature abnormality, the width of the abnormality interval for over-temperature abnormality may be narrower.

In an operation S503, the processor 120 may receive a state information value Sᵢ from the memory 110. In an operation S504, the processor 120 may determine whether the state information value Sᵢ is within a set abnormality interval.

For example, the processor 120 can determine whether the temperature of the battery 200 is higher than an upper limit temperature and lower than a DTC threshold corresponding to an over-temperature abnormality.

If the state information value Sᵢ is within the set abnormality interval (Yes in the operation S504), the processor 120 may accumulate a diagnosis count and diagnosis time for the corresponding state information in, respectively, operations S505 and S506.

For example, if the temperature of the battery 200 is higher than the upper limit temperature and lower than the DTC threshold corresponding to an over-temperature abnormality, the processor 120 may increase the accumulated diagnosis count for the over-temperature abnormality by one and increase the accumulated diagnosis time by the unit time of temperature measurement.

If the accumulated diagnosis count exceeds a reference count (Yes in an operation S507) or the accumulated diagnosis time exceeds a reference time (Yes in an operation S508), the processor 120 may generate and transmit a notification of abnormality diagnosis notification to the communication device 130 in an operation S509.

In embodiments in whether the battery 200 has an abnormality is determined based on the set abnormality interval, it is possible to reduce the possibility of over-diagnosis caused by sensor errors or disturbances and to ensure the reliability of the diagnosis result by providing a log of the state information, as compared with when determining whether the battery 200 has an abnormality based on a preset single value.

Further, by adjusting a DTC threshold through statistical analysis of information received by the server 300 from a plurality of apparatuses for managing a battery, the reliability of the diagnosis result can be further improved by providing an optimized abnormality interval that reflects the type, mileage, and age of a vehicle.

Although the present disclosure has been provided above in relation to embodiments shown in the drawings, it should be apparent to those having ordinary skill in the art that the present disclosure may be changed and modified in various ways without departing from the scope of the present disclosure, which is described in the following claims.

What is claimed is:

1. An apparatus for managing a battery in an electrified vehicle, the apparatus comprising:
a memory configured to store state information values including temperature, voltage, and resistance of the battery of the electrified vehicle over time;
a processor configured to determine whether the battery is abnormal based on a number of times and a duration that the state information values of the battery are included in a preset abnormality interval; and
a communication device configured to transmit an indication of an abnormal status of the battery to an external device.

2. The apparatus of claim 1, wherein the preset abnormality interval comprises an interval set between a preset normal operation limit value of the battery and a diagnostic trouble code (DTC) trigger threshold.

3. The apparatus of claim 2, wherein the DTC trigger threshold is received from a server.

4. The apparatus of claim 3, wherein the DTC trigger threshold received from the server is determined based on a distribution of a plurality of state information values and a frequency of abnormality occurrences, the distribution and the frequency being derived from batteries of a plurality of electrified vehicles.

5. The apparatus of claim 2, wherein the DTC trigger threshold is determined based on a type, mileage, and age of the electrified vehicle.

6. The apparatus of claim 1, wherein the processor is configured to:
determine an over-temperature abnormality interval based on a maximum operating temperature and a preset upper limit temperature of the battery; and
determine whether the battery has an over-temperature abnormality based on a number of times and a duration that the temperature of the battery is within the over-temperature abnormality interval.

7. The apparatus of claim 1, wherein the processor is configured to:
determine an over-voltage abnormality interval based on a maximum operating voltage and a preset upper limit voltage of the battery; and
determine whether the battery has an over-voltage abnormality based on a number of times and a duration that the voltage of the battery is within the over-voltage abnormality interval.

8. The apparatus of claim 1, wherein the processor is configured to:
determine a lower-voltage abnormality interval based on a minimum operating voltage and a preset lower limit voltage of the battery; and
determine whether the battery has a lower-voltage abnormality based on a number of times and a duration that the voltage of the battery is within the lower-voltage abnormality interval.

9. The apparatus of claim 1, wherein the processor is configured to:
determine a resistance abnormality interval based on minimum operating resistance and preset lower limit resistance of the battery; and
determine whether the battery has a resistance abnormality based on a number of times and a duration that the resistance of the battery is within the resistance abnormality interval.

10. The apparatus of claim 1, wherein the processor is configured to selectively store, in the memory, at least some state information based on variability of state information values over time.

11. The apparatus of claim 10, wherein the processor is configured to store, in the memory, state information values, excluding a state information value measured at a specific time based on a condition that i) a difference between the state information value measured at the specific time and a state information value measured immediately before the specific time is greater than a predetermined reference value or ii) a difference between the state information value measured at the specific time and a state information value measured immediately after the specific time is greater than the predetermined reference value.

12. The apparatus of claim 1, wherein the processor is configured to determine that the battery is in an abnormal state based on a condition that i) the number of times that a state information value of the battery is within the preset abnormality interval exceeds a predetermined reference number of times or ii) a duration for which a state information value of the battery is within the preset abnormality interval exceeds a predetermined reference time.

13. A method of managing a battery in an electrified vehicle, the method comprising:
storing state information values including temperature, voltage, and resistance of a battery of an electrified vehicle over time;
determining whether the battery is abnormal based on a number of times and a duration that the state information values of the battery are included in a preset abnormality interval set between a preset normal operating limit value of the battery and a diagnostic trouble code (DTC) trigger threshold; and
transmitting an indication of an abnormal status of the battery.

14. The method of claim 13, further comprising receiving the DTC trigger threshold from a server.

15. The method of claim 14, wherein the DTC trigger threshold received from the server is determined based on a distribution of a plurality of state information values and a frequency of abnormality occurrences of batteries of a plurality of electrified vehicles.

16. The method of claim 13, wherein the DTC trigger threshold is determined based on a type, mileage, and age of the electrified vehicle.

17. The method of claim 13, wherein the normal operation limit value comprises a maximum operating temperature, a maximum operating voltage, a minimum operating voltage, and a minimum operating resistance of the battery.

18. The method of claim 13, wherein storing the state information values includes selectively storing at least some state information based on variability of state information values over time.

19. The method of claim 18, wherein storing the state information values includes storing state information values, excluding a state information value measured at a specific time based on a condition that i) a difference between the state information value measured at the specific time and a state information value measured immediately before the specific time is greater than a predetermined exclusion reference value or ii) a difference between the state information value measured at the specific time and a state information value measured immediately after the specific time is greater than the predetermined exclusion reference value.

20. The method of claim 13, wherein determining whether the battery is abnormal includes determining that the battery is in an abnormal state based on a condition that i) a number of times a state information value of the battery is within the preset abnormality interval exceeds a predetermined reference number of times or ii) a duration for which a state information value of the battery is within the preset abnormality interval exceeds a predetermined reference time.
